(19) United States
(12) Patent Application Publication
(10) Pub. No.: US 2023/0174289 A1
(43) Pub. Date: Jun. 8, 2023

(54) Heated Food Packing Material

(71) Applicant: HOWA SANGYO CO., LTD., Chiba (JP)

(72) Inventor: Naoto Shirai, Chiba (JP)

(21) Appl. No.: 17/923,113

(22) PCT Filed: Apr. 9, 2021
(86) PCT No.: PCT/JP2021/014997

§ 371 Date: Nov. 3, 2022

(30) Foreign Application Priority Data
May 29, 2020 (JP) 2020-094248
Aug. 24, 2020 (JP) PCT/JP2020/031895

(51) Int. Cl. B65D 81/34; B65D 65/10; B65D 65/40; B32B 3/26; B32B 5/02

(52) U.S. Cl. CPC B65D 81/3446; B65D 65/10; B65D 65/40; B32B 3/266; B32B 5/022; B65D 2565/388; B32B 2307/724; B32B 2439/70

(57) ABSTRACT

Provided is a heated food packing material including a sheet-like body capable of wrapping a food to be heated; and a penetrating part penetrating the sheet-like body. The heated food packing material is configured to be used for heating the food wrapped therein in such a manner that one surface of the sheet-like body faces outside. The heated food packing material further includes a sheet-like covering part disposed to cover the penetrating part and configured to allow water vapor to pass therethrough.

### CROSS-REFERENCE TO RELATED APPLICATIONS

This application is the United States national phase of International Application PCT/JP2021/014997, filed Apr. 9, 2021, and claims priority to Japanese Patent Application No. 2020-094248 filed May 29, 2020 and International Application No. PCT/JP2020/031895 filed Aug. 24, 2020, the disclosures of which are hereby incorporated by reference in their entireties.

### BACKGROUND OF THE INVENTION

### Field of the Invention

The present invention relates to a heated food packing material used for wrapping food to be heated.

### Description of Related Art

Conventionally, food such as hamburgers and sandwiches are wrapped in a sheet-like packing material for sale at stores or the like. Known as such a packing material is a packing material including a sheet-like body having such a size as to be capable of wrapping food, a penetrating part that penetrates the sheet-like body, and a sheet-like sealing part configured to cover the penetrating part to seal the penetrating part (see Patent Literature 1). When the food is taken out from the inside of a packed product formed by packing food in such a packing material, the sheet-like body is cut from the penetrating part serving as a starting point to remove the packing material from the food.

Food that is heated before being eaten is sometimes heated in the state of being wrapped in the packing material. In this case, water vapor generated from the food tends to stay in the packed product. This causes a possibility that an increased pressure within the packed product damages the packed product or an excessive amount of water vapor is brought into contact with the food to impair the texture or taste of the food.

### CITATION LIST

### Patent Literature

Patent Literature 1: JP 2000-279113 A

### SUMMARY OF THE INVENTION

### Technical Problem

It is therefore an object of the present invention to provide a heated food packing material capable of discharging water vapor from an inside of a packed product formed by wrapping food in a sheet-like packing material.

### Solution to Problem

A heated food packing material according to the present invention includes: a sheet-like body capable of wrapping a food to be heated; a penetrating part penetrating the sheet-like body; and a sheet-like covering part disposed to cover the penetrating part and configured to allow water vapor to pass therethrough, the heated food packing material configured to be used for heating the food wrapped therein in such a manner that one surface of the sheet-like body faces outside.

It is preferable that, in the heated food packing material according to the present invention, the sheet-like covering part be formed of a non-woven cloth, and that the heated food packing material further include a sheet-like overlapping part disposed to overlap a surface of the sheet-like body covered with the sheet-like covering part, at a position away from the sheet-like covering part.

It is preferable that, in the heated food packing material according to the present invention, a pinching part be formed at an end of an area of the sheet-like body in which the penetrating part is formed, and the sheet-like body be configured to be capable of being cut from the penetrating part as a starting point.

Another heated food packing material according to the present invention includes:

a sheet member capable of wrapping a food to be heated, the sheet member including an easy-to-break part having a smaller breaking strength than another part of the sheet member; and a sheet-like covering part disposed to cover the easy-to-break part and configured to allow water vapor to pass therethrough, in which the easy-to-break part is broken in a state where a food is wrapped in the sheet member to form a penetrating part penetrating the sheet member so that a sheet-like body including the penetrating part is formed, the heated food packing material configured to be used for heating the food wrapped therein.

### BRIEF DESCRIPTION OF THE DRAWINGS

FIG. 1 is a perspective view showing a heated food packing material according to a first embodiment of the present invention.

FIG. 2 is a perspective view showing a packed product formed by packing food with the heated food packing material according to the embodiment.

FIG. 3 is a perspective view showing a heated food packing material according to a second embodiment of the present invention from which a sheet-like covering part is removed.

FIG. 4 is a perspective view showing the heated food packing material according to the embodiment.

FIG. 5 is a perspective view showing a heated food packing material according to another embodiment of the present invention.

FIG. 6 is a perspective view showing a packed product formed by packing food with the heated food packing material according to the embodiment.

FIG. 7 is a perspective view showing a packed product formed by packing food with a heated food packing material according to yet another embodiment of the present invention.

### DESCRIPTION OF THE INVENTION

A description will be hereinafter given on embodiments of a heated food packing material according to the present invention with reference to the drawings. In the drawings, the same or corresponding elements are denoted by the same reference signs, and the description thereon will not be repeated. Further, in the description hereinafter, one direction refers to a direction along the x-axis in the coordinate axes of each figure, and the other direction crossing the one direction refers to a direction along the y-axis in the coordinate axes of each figure.

### First Embodiment

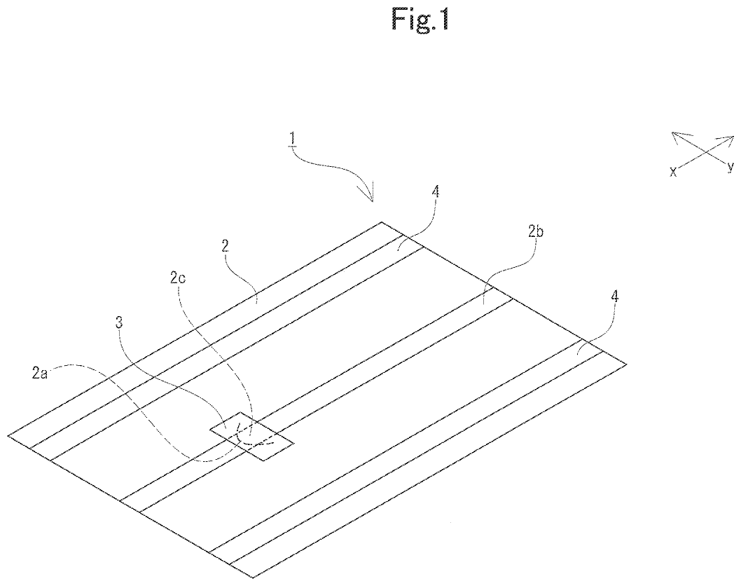

As shown in FIG. 1, a heated food packing material 1 according to this embodiment is formed into a sheet shape. The heated food packing material 1 includes a sheet-like body 2 configured to wrap food (e.g., a hamburger or sandwich) with one surface of the sheet-like body 2 facing outside, and a penetrating part 2a penetrating the sheet-like body 2. The heated food packing material 1 further includes a sheet-like covering part 3 covering the penetrating part 2a, and a sheet-like overlapping part 4 disposed to overlap a surface of the sheet-like body 2 on which the sheet-like covering part 3 is placed.

The sheet-like body 2 can be at least partially divided in the other direction (hereinafter referred to also as a second direction) crossing one direction (hereinafter referred to also as a first direction). Specifically, the sheet-like body 2 is at least partially divided in the second direction by being cut on a line to be cut (virtual line) extending in the first direction. In this embodiment, the sheet-like body 2 includes a cut tape 2b disposed to extend in the first direction. The cut tape 2b is disposed substantially at the center in the second direction of the sheet-like body 2. The sheet-like body 2 is cut along the cut tape 2b to cause both sides of the cut tape 2b to be at least partially divided from each other in the second direction.

The penetrating part 2a is formed in an area inside an outer peripheral end of the sheet-like body 2. The penetrating part 2a is formed on one side in the first direction of the center of the sheet-like body 2, and formed substantially at the center in the second direction of the sheet-like body 2. The penetrating part 2a is formed at a position at which it does not overlap an area of the sheet-like body 2 where the penetrating part 2a is not present when food is wrapped in the heated food packing material 1.

Further, the penetrating part 2a is composed of a cutting line penetrating the sheet-like body 2. The cutting line is formed in a recessed shape (U shape) opening in the first direction. This forms a pinching part 2c capable of being pinched by, for example, fingers at an end of an area of the sheet-like body 2 in which the penetrating part 2a is formed (specifically, an area inside the penetrating part 2a (cutting line)). Further, the penetrating part 2a (cutting line) crosses the cut tape 2b at a position between both ends of the penetrating part 2a (in other words, the pinching part 2c overlaps the cut tape 2b). With this configuration, the sheet-like body 2 is cut (specifically, cut along the cut tape 2b on both sides of the cut tape 2b) from the both ends of the penetrating part 2a (cutting line) as starting points by pulling the pinching part 2c from one end side to the other end side in the first direction of the sheet-like body 2 (specifically, to a side on which the cutting line formed in a recessed shape opens). Thus, a part of the sheet-like body 2 (specifically, an area of the sheet-like body 2 on the other end side in the first direction of the penetrating part 2a) is divided in the second direction.

The sheet-like covering part 3 is disposed to overlap an inner area of the outer peripheral end of the sheet-like body 2. The sheet-like covering part 3 is disposed on the one end side in the first direction of the center of the sheet-like body 2, and is disposed substantially at the center in the second direction of the sheet-like body 2. The sheet-like covering part 3 is disposed to overlap the other surface of the sheet-like body 2 (specifically, a surface thereof on a food side when the sheet-like body 2 is used to wrap the food), in other words, disposed to cover the penetrating part 2a from the other surface side thereof. The sheet-like covering part 3 is disposed to cover a part of the cut tape 2b (specifically, a part positioned inside the pinching part 2c), specifically, disposed to overlap the cut position of the sheet-like body 2.

The sheet-like covering part 3 allows water vapor to pass therethrough. A sheet member forming the sheet-like covering part 3 is not particularly limited, and for example, non-woven cloth, a sheet member having a plurality of through holes, paper, or the like can be used, among which the non-woven cloth is preferably used in terms of being capable of suppressing dust or other foreign objects from passing through the sheet-like covering part 3 and contaminating food.

The sheet-like covering part 3 has at least a part thereof attached to the sheet-like body 2. For example, an annular area formed along the outer peripheral shape of the sheet-like covering part 3 (e.g., an area having a quadrangular frame shape) can be attached to the sheet-like body 2, or one surface of the sheet-like covering part 3 can be entirely attached to the sheet-like body 2. A method for attaching the sheet-like covering part 3 to the sheet-like body 2 is not particularly limited, and for example, heat sealing, ultrasonic sealing, an adhesive, or the like can be used.

The thickness of the sheet-like covering part 3 is not particularly limited. For example, the thickness of the sheet-like covering part 3 can be substantially the same as the thickness of the sheet-like overlapping part 4, can be larger than the thickness of the sheet-like overlapping part 4, or can be smaller than the thickness of the sheet-like overlapping part 4. The specific thickness of the sheet-like covering part 3 can be, for example, 20 to 300 μm (specifically, about 150 μm). Herein, substantially the same thickness means that the ratio of the thickness of the sheet-like covering part 3 to the thickness of the sheet-like overlapping part 4 is 0.9 to 1.1.

The sheet-like overlapping part 4 is formed into a strip shape extending in the first direction. The sheet-like overlapping part 4 is disposed to extend across the entire length between both ends in the first direction of the sheet-like body 2. The sheet-like overlapping part 4 is disposed at a position away from the sheet-like covering part 3. Specifically, the sheet-like overlapping part 4 is disposed at a position away on an end side in the second direction of the sheet-like body 2 from the sheet-like covering part 3. More specifically, the sheet-like overlapping part 4 is disposed closer to an end side in the second direction of the sheet-like body 2 than the center thereof. The sheet-like overlapping part 4 is disposed at a position away from an end edge in the second direction of the sheet-like body 2 to the central side thereof.

Further, the sheet-like overlapping part 4 is disposed to overlap the other surface of the sheet-like body 2 (i.e., the surface thereof on the food side when the sheet-like body 2 is used to wrap the food). The sheet-like overlapping part 4 is disposed not to overlap a cutting position of the sheet-like body 2 (i.e., the cutting position extending in the first direction), specifically, disposed at a position away in the second direction from the cut tape 2b. In this embodiment, the heated food packing material 1 includes two sheet-like overlapping parts 4, and the two sheet-like overlapping parts 4 are disposed with a clearance therebetween in the second direction (specifically, disposed to each overlap each of the both end portions in the second direction of the sheet-like body 2). Further, the penetrating part 2a, the sheet-like covering part 3, and the cut tape 2b are positioned between the two sheet-like overlapping parts 4 in the second direction.

Each of the sheet-like overlapping parts 4 has at least a part thereof attached to the sheet-like body 2. For example, a portion inside both ends in the second direction of the sheet-like overlapping part 4 can be attached to the sheet-like body 2 along the first direction, or one surface of the sheet-like overlapping part 4 can be entirely attached to the sheet-like body 2. A method for attaching the sheet-like overlapping part 4 to the sheet-like body 2 is not particularly limited, and for example, heat sealing, ultrasonic sealing, an adhesive, or the like can be used.

The thickness of the sheet-like overlapping part 4 is not particularly limited. For example, the thickness of the sheet-like overlapping part 4 can be substantially the same as the thickness of the sheet-like covering part 3, or can be smaller or larger than the thickness of the sheet-like covering part 3. The thickness of the sheet-like overlapping part 4 can be substantially the same as the thickness of the cut tape 2b, or can be smaller or larger than the thickness of the cut tape 2b. Herein, being substantially the same means that the ratio of the thickness of the sheet-like overlapping part 4 to the thickness of the sheet-like covering part 3 (or the cut tape 2b) is 0.9 to 1.1.

A sheet member forming the sheet-like overlapping part 4 is not particularly limited, and for example, the same sheet member as or a different sheet member from the sheet-like body 2 and/or the cut tape 2b can be used.

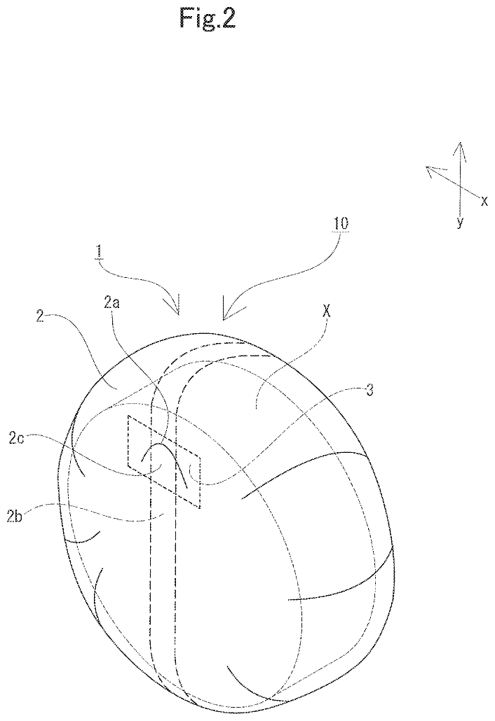

When food is wrapped using the heated food packing material 1 configured as above, a food X is wrapped in the heated food packing material 1 (specifically, the sheet-like body 2) in conformity with the shape of the food X so that the one surface of the sheet-like body 2 (i.e., the surface on which the sheet-like covering part 3 is not placed) faces outside as shown in FIG. 2. A packed product 10 with the food X wrapped in the heated food packing material 1 is thus formed. In so doing, water vapor can be effectively discharged through the penetrating part 2a at the time of heating the food X within the packed product 10 as will be described later when the penetrating part 2a is positioned to overlap an end or a side of the food X (in other words, the penetrating part 2a is positioned near an end or on a lateral surface of the packed product 10) when the packed product 10 is viewed from the front. In this case, the sheet-like covering part 3 can be positioned to extend from a vicinity of the end to the side of the packed product 10, or can be positioned at a vicinity of the end or the side of the packed product 10, when the packed product 10 is viewed from the front.

In a state where the packed product 10 is formed as described above, the food X is heated by a heating device such as a microwave oven or an infrared heater. When the food X heated within the packed product 10 is to be eaten, the pinching part 2c is pulled along the cut tape 2b. Thus, the sheet-like body 2 is cut from the penetrating part 2a (specifically, the both ends of the cut line) as the starting points through the lines to be cut, the lines extending on both sides of the cut tape 2b along the cut tape 2b. This configuration allows the heated food packing material 1 to be partially divided in the second direction. One side and the other side of the heated food packing material 1 having a border along the cut portion thereof are made to be relatively separated from each other in the second direction to thereby allow the food X to be exposed from the packed product 10 for eating.

When the food X is exposed from the packed product 10, the sheet-like covering part 3 if being formed of a non-woven cloth is flexible and can thus be easily removed so as not to cause hindrance when the food X is eaten. The sheet-like covering part 3 if being formed of a non-woven cloth is easily visible and can thus be suppressed from being eaten by mistake. When the food X is exposed from the packaged product 10 as described above, the sheet-like covering part 3 is connected to the sheet-like body 2 on one side or the other side of the heated food packing material 1, which can prevent the sheet-like covering part 3 and the sheet-like body 2 from being respectively separate wastes.

As described above, the heated food packing material 1 according to this embodiment allows water vapor to be discharged from the inside of the packed product 10 even when the food X is heated in the packed product 10 formed with the food X wrapped in the heated food packing material 1.

That is, when the food X is heated in the state where the packed product 10 is formed, water vapor discharged through the penetrating part 2a passes through the sheet-like covering part 3, and can thus be discharged to the outside of the packed product 10. The penetrating part 2a covered with the sheet-like covering part 3 can suppress foreign objects from intruding into the packed product 10.

Since the sheet-like overlapping part 4 is disposed at a position away from the sheet-like covering part 3 to overlap a surface of the sheet-like body 2 covered with the sheet-like covering part 3, a difference is made small between the thickness of a portion of the heated food packing material 1 including the sheet-like covering part 3 and the thickness of a portion thereof including the sheet-like overlapping part 4. That is, the sheet-like overlapping part 4 can adjust the thickness of a portion of the heated food packing material 1 including no sheet-like covering part 3. This configuration can suppress difficulty in stacking a plurality of the heated food packing materials 1 or difficulty in keeping the heated food packing materials 1 stacked when the plurality of heated food packing materials 1 are stacked on each other (for example, when the heated food packing materials 1 are stacked on each other or when a plurality of heated food packing materials 1 continuing to each other into an elongated shape are rolled up).

The pinching part 2c is formed at the end of the area of the sheet-like body 2 in which the penetrating part 2a is formed. In other words, a portion of the sheet-like body 2 adjacent to the penetrating part 2a is a pinching part 2c. This configuration allows the sheet-like body 2 to be cut from the penetrating part 2a as the starting point by pinching and pulling the pinching part 2c.

### Second Embodiment

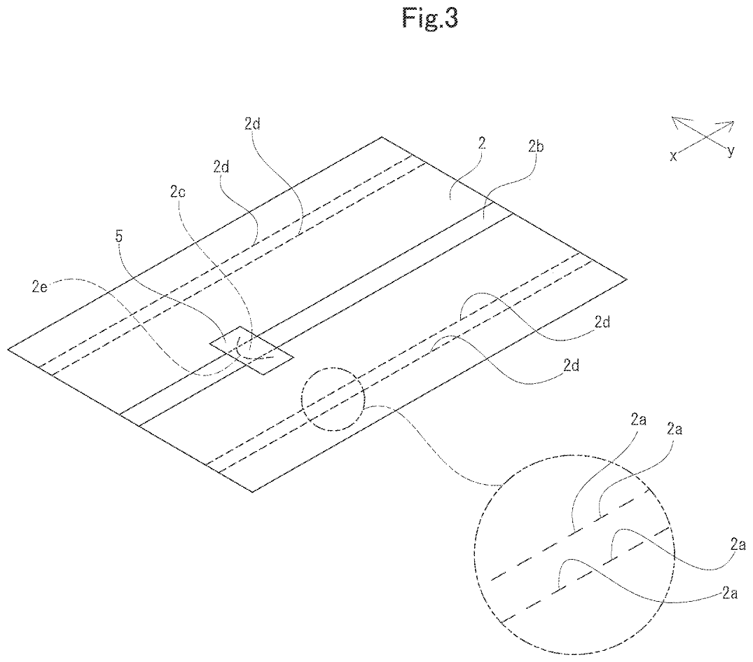

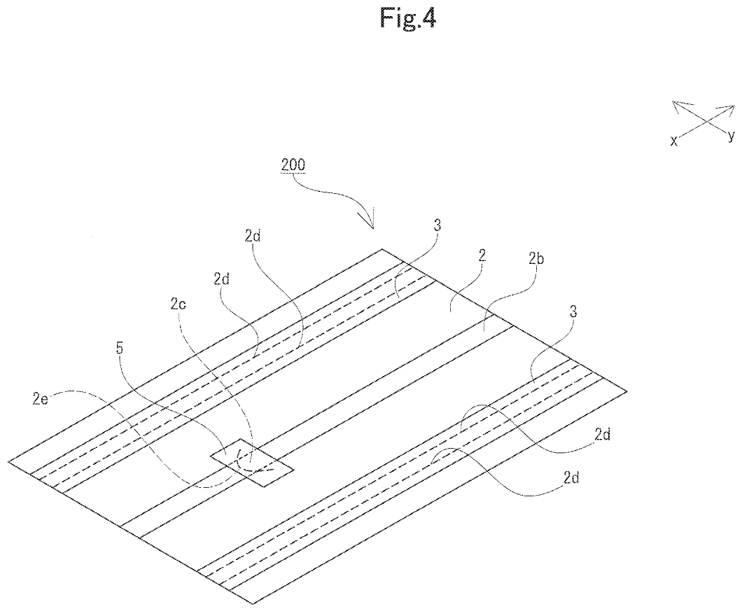

As shown in FIGS. 3 and 4, a heated food packing material 200 includes a penetrating part 2a and a sheet-like covering part 3, which are different from those of the heated food packing material 1 according to the first embodiment. Thus, a description will be hereinafter given on the configurations different from those of the first embodiment.

In this embodiment, as shown in FIG. 3, the penetrating part 2a is formed at a position away in the second direction from the center in the second direction of the sheet-like body 2. A plurality of the penetrating parts 2a are formed at intervals interposed therebetween in the first direction. Specifically, the plurality of penetrating parts 2a are formed at intervals across substantially the entire length in the first direction of the sheet-like body 2. With this configuration, the sheet-like body 2 in this embodiment includes a penetrating perforation 2d formed of the plurality of penetrating parts 2a, the penetrating perforation 2d extending in the first direction. At least two penetrating perforations 2d are formed so that the center in the second direction of the sheet-like body 2 is positioned therebetween. Specifically, a plurality of (specifically, two) penetrating perforations 2d are formed at positions away on one side in the second direction from the center in the second direction of the sheet-like body 2. Further, another plurality of (specifically, two) penetrating perforations 2d are formed at positions away on the other side in the second direction from the center in the second direction of the sheet-like body 2.

In this embodiment, as shown in FIGS. 3 and 4, the sheet-like covering part 3 is disposed at a position away in the second direction from the center in the second direction of the sheet-like body 2. Such a sheet-like covering part 3 is disposed to cover the plurality of penetrating parts 2a (specifically, at least two penetrating parts 2a forming the penetrating perforation 2d). The sheet-like covering part 3 is formed in a strip shape extending in the first direction, and covers at least one (specifically, two) penetrating perforations 2d (specifically, covers the entire penetrating perforations 2d). At least two sheet-like covering parts 3 are disposed away from each other in the second direction so that the center in the second direction of the sheet-like body 2 is positioned therebetween.

Each of the at least two sheet-like covering parts 3 disposed with a clearance therebetween in the second direction covers at least one (specifically, two) penetrating perforation 2d.

In this embodiment, the sheet-like body 2 includes a cutting-purpose penetrating part 2e formed to penetrate the sheet-like body 2 at a position away from the penetrating parts 2a (specifically, the penetrating perforations 2d) to serve as the starting point from which the sheet-like body 2 is cut. Specifically, the sheet-like body 2 includes the cutting-purpose penetrating part 2e on the central side in the second direction of the penetrating parts 2a (specifically, the penetrating perforations 2d).

The cutting-purpose penetrating part 2e is formed in an area inside an outer peripheral end of the sheet-like body 2. The cutting-purpose penetrating part 2e is formed on one side in the first direction of the center of the sheet-like body 2, and formed substantially at the center in the second direction of the sheet-like body 2. The cutting-purpose penetrating part 2e is formed at a position at which it does not overlap an area of the sheet-like body 2 where the cutting-purpose penetrating part 2e is not present when food is wrapped in the heated food packing material 200.

Further, the cutting-purpose penetrating part 2e is composed of a cutting line penetrating the sheet-like body 2. The cutting line is formed in a recessed shape (U shape) opening in the first direction. This forms a pinching part 2c capable of being pinched by, for example, fingers at an end of an area of the sheet-like body 2 in which the cutting-purpose penetrating part 2e is formed (specifically, an area inside the cutting-purpose penetrating part 2e (cutting line)). Further, the cutting-purpose penetrating part 2e (cutting line) crosses the cut tape 2b at a position between both ends of the cutting-purpose penetrating part 2e (in other words, the pinching part 2c overlaps the cut tape 2b). With this configuration, the sheet-like body 2 is cut (specifically, cut along the cut tape 2b on both sides of the cut tape 2b) from the both ends of the cutting-purpose penetrating part 2e (cutting line) as starting points by pulling the pinching part 2c from one end side to the other end side in the first direction of the sheet-like body 2 (specifically, to a side on which the cutting line formed in a recessed shape opens). Thus, a part of the sheet-like body 2 (specifically, an area of the sheet-like body 2 on the other end side in the first direction of the cutting-purpose penetrating part 2e) is divided in the second direction.

The heated food packing material 200 according to this embodiment includes a sheet-like closing part 5 closing the cutting-purpose penetrating part 2e.

The sheet-like closing part 5 is disposed to overlap an inner area of the outer peripheral end of the sheet-like body 2. The sheet-like closing part 5 is disposed on the one end side in the first direction of the center of the sheet-like body 2, and is disposed substantially at the center in the second direction of the sheet-like body 2. The sheet-like closing part 5 is disposed to overlap the other surface of the sheet-like body 2 (specifically, on a surface thereof on a food side when the sheet-like body 2 is used to wrap the food), in other words, disposed to cover the cutting-purpose penetrating part 2e from the other surface side thereof. The sheet-like closing part 5 is disposed to cover a part of the cut tape 2b (specifically, a part positioned inside the pinching part 2c), specifically, disposed to overlap the cut position of the sheet-like body 2.

The sheet-like closing part 5 has at least a part thereof attached to the sheet-like body 2. For example, an annular area formed along the outer peripheral shape of the sheet-like closing part 5 (e.g., an area having a quadrangular frame shape) can be attached to the sheet-like body 2, or one surface of the sheet-like closing part 5 can be entirely attached to the sheet-like body 2. A method for attaching the sheet-like closing part 5 to the sheet-like body 2 is not particularly limited, and for example, heat sealing, ultrasonic sealing, an adhesive, or the like can be used.

A sheet member forming the sheet-like closing part 5 is not particularly limited, and for example a resin sheet can be used. The thickness of the sheet-like closing part 5 is not particularly limited. For example, the thickness of the sheet-like closing part 5 can be substantially the same as the thickness of the sheet-like covering part 3, can be larger than the thickness of the sheet-like covering part 3, or can be smaller than the thickness of the sheet-like covering part 3. For example, a specific thickness of the sheet-like closing part 5 can be, 10 to 20 μm, can be 10 to 15 μm, can be 16 to 20 μm, can be 20 to 40 μm, and can be 60 μm or more. Herein, substantially the same thickness means that the ratio of the thickness of the sheet-like closing part 5 to the thickness of the sheet-like covering part 3 is 0.9 to 1.1.

In this embodiment, at least two sheet-like covering parts 3 each having a strip shape are disposed with a clearance therebetween in the second direction as described above; thus, the two sheet-like covering parts 3 produce an effect (which will be described later) similar to the effect of the sheet-like overlapping parts 4 of the first embodiment. Thus, in this embodiment, the configuration can be such that no sheet-like overlapping part 4 is provided.

The plurality of penetrating parts 2a formed at intervals in the first direction form the penetrating perforation 2d extending in the first direction. This configuration relatively enlarges an area of the packed product 10 through which water vapor can be discharged, and thus allows water vapor to be more effectively discharged to the outside of the packed product 10.

Since the penetrating perforation 2d is formed to extend in the first direction, the penetrating perforation 2d can be arranged into a U shape when the packed product 10 is formed. Then, at least a part of the food X is positioned between ends of the penetrating perforation 2d arranged in a U shape (in other words, the penetrating perforation 2d is arranged from one surface to the opposite surface of the food X) to thereby allow water vapor to be more effectively discharged to the outside of the packed product 10.

Since the sheet-like covering part 3 formed of a non-woven cloth is formed into a strip shape extending in the first direction, the sheet-like covering part 3 can more effectively absorb water (e.g., water droplets) within the packed product 10. This configuration can suppress water from deteriorating the food X or from impairing the texture or flavor of the food X.

Since the penetrating perforation 2d is formed at a position away from the cutting-purpose penetrating part 2e serving as the starting point from which the sheet-like body 2 is cut, water vapor is to be discharged through a position away from the cutting-purpose penetrating part 2e. This configuration can suppress a hand and fingers of a user from being burnt or wet by water vapor even when the user brings his or her hand and fingers close to the cutting-purpose penetrating part 2e to cut the sheet-like body 2.

The heated food packing material according to the present invention is not limited to the aforementioned embodiments, and various modifications can be made without departing from the gist of the present invention. It is a matter of course that configurations, methods, or the like of the aforementioned plurality of embodiments can be arbitrarily employed in combination (a configuration, a method, or the like of one embodiment can be applied to a configuration, a method, or the like of another embodiment), and further a configuration, a method, or the like according to various modified examples to be described below can be arbitrarily selected to apply to a configuration, a method, or the like according to any of the aforementioned embodiments.

The aforementioned embodiment has been described by taking, for example, the case where the sheet-like body 2 is cut from the penetrating part 2a (cutting line) as the starting point, without limitation thereto. For example, the configuration can be such that the sheet-like body 2 is cut from a broken part (e.g., cutting line, perforated line, half-cut part) formed at a position away from the penetrating part 2a as a starting point.

The aforementioned embodiment has been described by taking, for example, the case where the sheet-like covering part 3 is disposed to overlap the cutting position of the sheet-like body 2, without limitation thereto. For example, the configuration can be such that the sheet-like covering part 3 is disposed at a position not overlapping the cutting position of the sheet-like body 2.

The aforementioned embodiment has been described by taking, for example, the case where the sheet-like covering part 3 is disposed to overlap the other surface of the sheet-like body 2 (i.e., the surface thereof on the food side when the sheet-like body 2 is used to wrap the food), without limitation thereto. For example, the configuration can be such that the sheet-like covering part 3 overlaps the one surface of the sheet-like body 2 (i.e., the surface thereof facing outside when the sheet-like body is used to wrap the food).

The aforementioned embodiment has been described by taking, for example, the case where the penetrating part 2a is formed of a cutting line, without limitation thereto. For example, the configuration can be such that the penetrating part 2a is formed of at least one through hole.

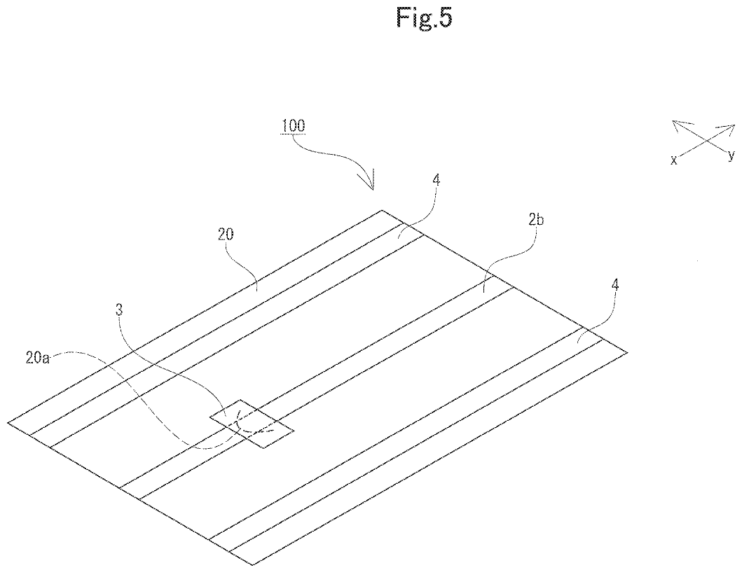

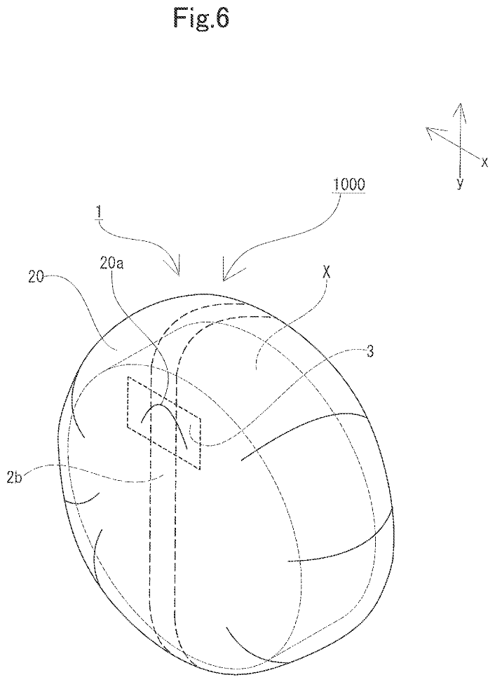

A heated food packing material 100 according to another embodiment of the present invention can be, as shown in FIG. 5, a heated food packing material including: a sheet member 20 capable of wrapping the food X to be heated, the sheet member 20 including an easy-to-break part 20a having a smaller breaking strength than other parts thereof; and a sheet-like covering part 3 disposed to cover the easy-to-break part 20a and configured to allow water vapor to pass therethrough. Such a heated food packing material 100 is configured to have the easy-to-break part 20a broken in the state where the food X is wrapped therein (in the state where a packed product 1000 is formed) as shown in FIG. 6 to form a penetrating part 2a, thereby forming the sheet-like body 2 having the penetrating part 2a as shown in FIG. 2. The timing at which the easy-to-break part 20a is broken is not particularly limited, and for example can be immediately before the food X is heated, or can be during heating of the food X. A method for breaking the easy-to-break part 20a is not particularly limited, and the configuration can be such that a portion close to the easy-to-break part 20a is pinched and pulled with fingers to thereby break the easy-to-break part 20a, or that the pressure of water vapor generated when heating food breaks the easy-to-break part 20a. The easy-to-break part 20a is not particularly limited, and examples thereof include a half-cut part and a perforated line. The shape of the easy-to-break part 20a is not particularly limited, and preferable examples thereof include a shape conforming to the shape of the penetrating part 2.

The heated food packing material 100 configured as above can be in the state of having no penetrating part 2a formed therein as shown in FIG. 6 until the food X is heated, and can thus prevent foreign objects from intruding into the packed product 1000. The heated food packing material 100 configured as above can discharge water vapor through the penetrating part 2a by having the easy-to-break part 20a broken to form the penetrating part 2a as shown in FIG. 2.

The aforementioned embodiment has been described by taking, for example, the case where the sheet-like overlapping part 4 is continuously disposed to extend across the entire length between both ends in the first direction of the sheet-like body 2, without limitation thereto. For example, the configuration can be such that a plurality of sheet-like overlapping parts 4 are disposed at intervals in the first direction. The aforementioned embodiment has been described by taking, for example, the case where a pair of sheet-like overlapping parts 4 are provided, without limitation thereto. For example, the configuration can be such that only one sheet-like overlapping part 4 is provided.

The aforementioned embodiment has been described by taking, for example, the case where the sheet-like overlapping part 4 is formed separately from the sheet-like body 2, without limitation thereto. For example, the sheet-like overlapping part 4 can be formed integrally with the sheet-like body 2. Specifically, the configuration can be such that opposed ends of a single sheet member forming the sheet-like body 2 and the sheet-like overlapping part 4 are folded so that the folded ends of the sheet member form the respective sheet-like overlapping parts 4 and the remaining part of the sheet member forms the sheet-like body 2.

In the sheet-like body 2, the position at which the penetrating part 2a is formed and the position at which the sheet-like covering part 3 is disposed are not particularly limited, but it is preferable that the position at which the penetrating part 2a is formed and the position at which the sheet-like covering part 3 is formed do not overlap other positions in the sheet-like body 2.

The aforementioned embodiment has been described by taking, for example, the case where an area of the sheet-like body 2 on the other end side in the first direction of the penetrating part 2a (that is, a part of the sheet-like body 2) is dividable in the second direction, without limitation thereto. For example, the configuration can be such that the entire sheet-like body 2 is dividable in the second direction.

The aforementioned embodiment has been described by taking, for example, the case where the pinching part 2c is formed inside the penetrating part 2 having a recessed shape (U shape), without limitation thereto. For example, the configuration can be such that an end adjacent to the penetrating part 2a formed into a linear shape (i.e., at least one of the opposed ends of the penetrating part 2a) serves as the pinching part 2c.

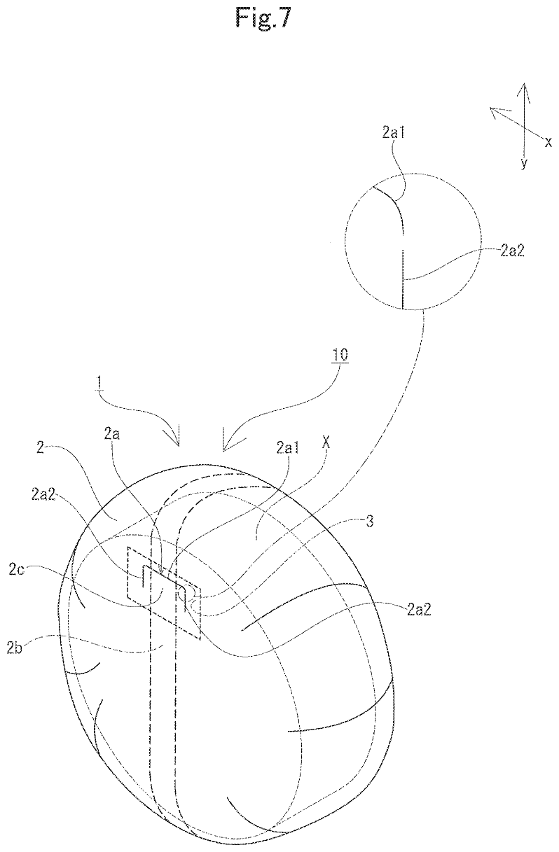

The aforementioned embodiment has been described by taking, for example, the case where the penetrating part 2a is formed of a continuous cutting line, without limitation thereto. For example, as shown in FIG. 7, the configuration can be such that the penetrating part 2a is formed of an intermittently formed cutting line (in other words, a cutting line partially having uncut portions). Specifically, the configuration can be such that the penetrating part 2a has a cutting line 2a1 formed into a recessed shape (U shape); and two cutting lines 2a2 formed at positions away (i.e., positions away by about 0.5 mm to 2 mm) from the respective ends of the cutting line 2a1 in a direction in which the cutting line 2a1 is open, the two cutting lines 2a2 linearly extending in the direction in which the cutting line 2a1 is open. A portion in which the sheet member is not cut (i.e., an uncut part) is formed between each of the both ends of the recessed cutting line 2a1 and the corresponding one of the two linear cutting lines 2a2. This can suppress the sheet-like body 2 from being unexpectedly cut from the both ends of the penetrating part 2a (specifically, the respective ends of the two linear cutting lines 2a2) as the starting points.

### REFERENCE SIGNS LIST

1, 100, 200: Heated food packing material
2: Sheet-like body
20: Sheet member
2a: Penetrating part
20a: Easy-to-break part
2b: Cut tape
2c: Pinching part
2d: Penetrating perforation
2e: Cutting-purpose penetrating part
3: Sheet-like covering part
4: Sheet-like overlapping part
5: Sheet-like closing part
10, 1000: Packed product
X: Food

1. A heated food packing material comprising:
a sheet-like body capable of wrapping a food to be heated;
a penetrating part penetrating the sheet-like body; and
a sheet-like covering part disposed to cover the penetrating part and configured to allow water vapor to pass therethrough,
and the heated food packing material configured to be used for heating the food wrapped therein in such a manner that one surface of the sheet-like body faces outside.

2. The heated food packing material according to claim 1, wherein
the sheet-like covering part is formed of a non-woven cloth, and
the heated food packing material further comprises a sheet-like overlapping part disposed to overlap a surface of the sheet-like body covered with the sheet-like covering part, at a position away from the sheet-like covering part.

3. The heated food packing material according to claim 1, wherein
a pinching part is formed at an end of an area of the sheet-like body in which the penetrating part is formed, and
the sheet-like body is configured to be capable of being cut from the penetrating part as a starting point.

4. A heated food packing material comprising:
a sheet member capable of wrapping a food to be heated, the sheet member comprising an easy-to-break part having a smaller breaking strength than another part of the sheet member; and
a sheet-like covering part disposed to cover the easy-to-break part and configured to allow water vapor to pass therethrough,
wherein the easy-to-break part is broken in a state where a food is wrapped in the sheet member to form a penetrating part penetrating the sheet member so that a sheet-like body comprising the penetrating part is formed, and
the heated food packing material configured to be used for heating the food wrapped therein.

5. The heated food packing material according to claim 1, further comprising a plurality of the penetrating parts formed at intervals in one direction to thereby form a penetrating perforation extending in the one direction.

6. The heated food packing material according to claim 5, wherein
the sheet-like body comprises a cutting-purpose penetrating part at a position away from the penetrating perforation, with the cutting-purpose penetrating part formed to penetrate the sheet-like body to serve as a starting point from which the sheet-like body is cut.

7. The heated food packing material according to claim 2, wherein
a pinching part is formed at an end of an area of the sheet-like body in which the penetrating part is formed, and
the sheet-like body is configured to be capable of being cut from the penetrating part as a starting point.
